(19) United States
(12) Patent Application Publication
(10) Pub. No.: US 2025/0378422 A1
(43) Pub. Date: Dec. 11, 2025

(54) REGULATORY PATHWAY IDENTIFICATION SYSTEM FOR MEDICAL PRODUCTS

(71) Applicant: Patrick Mahoney, Cleveland Heights, OH (US)

(72) Inventor: Patrick Mahoney, Cleveland Heights, OH (US)

(21) Appl. No.: 19/046,598

(22) Filed: Feb. 6, 2025

Related U.S. Application Data
(60) Provisional application No. 63/657,798, filed on Jun. 8, 2024.

(51) Int. Cl. G06Q 10/10; G06Q 50/26

(52) U.S. Cl. CPC G06Q 10/103; G06Q 50/26

(57) ABSTRACT

An identification system for identifying regulatory pathways for medical product development including a host server, a user authentication system, a user interface, regulatory logic for identifying a regulatory affairs development pathway, and a regulatory database. The regulatory logic analyzes user responses to determine regulatory pathways based on information stored in the regulatory database. The user authentication system stores account preferences, payment methods, identified regulatory pathways, and/or product development information. The regulatory logic communicates with the user interface to present prompts, questions, input fields, and/or guiding comments to the user. The regulatory database stores information on regulations, guidance documents, Acts of Congress, applicable fees, submission information, and/or development timelines. The identification system includes prompt display for presenting user prompts associated with guiding comments. The user prompts comprise multiple choice questions, open-ended questions, or Boolean questions such as true/false questions. The guiding comments are hidden until selected by the user.

### CROSS REFERENCE TO RELATED APPLICATIONS

This application is a Utility Patent application claiming priority to U.S. Provisional Patent Application Ser. No. 63/657,798 filed on Jun. 8, 2024, which is incorporated by reference herein in its entirety.

### COPYRIGHT

A portion of the disclosure of this patent document contains material that is subject to copyright protection. The copyright owner has no objection to the facsimile reproduction by anyone of the patent document or the patent disclosure as it appears in the Patent and Trademark Office patent file or records but otherwise reserves all copyright rights whatsoever.

Trademarks used in the disclosure of the invention, and the applicants, make no claim to any trademarks referenced.

### BACKGROUND OF THE INVENTION

### 1) Field of the Invention

The invention relates to systems and methods for regulatory affairs pathway identification for medical product development.

### 2) Description of related art

Medical product development is a long and difficult process, especially when the amount of regulatory consultation, guidance, and involvement is considered. The United States Food and Drug Administration and other regulating bodies have many different disconnected requirements and pathways for a variety of medical products. Depending on the medical product, patient population, and disease or condition, there may be many different potential regulatory pathways and strategies, each with their own benefits and/or drawbacks. This burden is causing many medical products to get stuck in the development process, and some are abandoned due to missed potential development opportunities and pathways.

Regulatory affairs professionals play a crucial role in guiding medical product development through the intricate landscape of regulations, guidelines, and approval processes set forth by various regulatory agencies, health authorities or other regulatory organizations which guide development and use of medical or health products worldwide. Over the years, the regulatory environment for medical products has become increasingly complex, with new regulations, guidance documents, and developmental pathways being introduced regularly. This complexity can make it challenging for companies, especially smaller organizations or startups, to identify the most appropriate regulatory strategy for their specific medical product.

The regulatory pathway for a medical product can significantly impact its development timeline, costs, and ultimate success in reaching the market. Different medical product types, such as drugs, medical devices, biologics, or combination products, may have distinct regulatory requirements and potential pathways. Additionally, factors such as the medical product's intended use, target population, and level of risk can influence the regulatory approach.

Traditionally, navigating the regulatory landscape has relied heavily on the expertise of experienced regulatory affairs professionals. However, this approach can be resource-intensive and may not always provide consistent or up-to-date information across different projects or organizations. Furthermore, the rapid pace of technological advancements in the medical field has led to the emergence of novel product types that may not fit neatly into existing regulatory categories, further complicating the process of identifying appropriate regulatory pathways.

There is a growing need for tools and systems that can assist regulatory affairs professionals, product developers, and other stakeholders in efficiently identifying and understanding potential regulatory pathways for their medical products. Such tools could help streamline the regulatory strategy development process, reduce the risk of pursuing suboptimal regulatory approaches, and ultimately facilitate the timely development and approval of innovative medical products.

Improved methods for regulatory pathway identification could potentially benefit various stakeholders in the medical product development ecosystem, including pharmaceutical companies, medical device manufacturers, biotechnology firms, academic researchers, and regulatory agencies themselves. By providing more accessible regulatory information, such methods could help level the playing field for smaller organizations and potentially accelerate the development of innovative medical products to address unmet medical needs. Additionally, the methods may be used for companies that are looking to expand into new areas that their current staff may have only limited knowledge or exposure to, such as a cell therapy company looking to develop a gene therapy product. The company regulatory team is likely filled with cell therapy experts, but gene therapy carries with it another level of understanding and different requirements than that the team may already be familiar with.

As the field of medical product development continues to evolve, there remains an opportunity to develop more efficient and effective approaches to regulatory pathway identification and strategy development. Such approaches could leverage advances in information technology, data analytics, open-source code, health authority database outputs, application programming interfaces and regulatory science to provide more tailored, accurate, and timely guidance to those navigating the complex regulatory landscape of medical product development.

What is needed, therefore, is a system and method for regulatory affairs pathway identification for medical product development, specifically to better guide medical product development through the overwhelming regulatory process and identify the options for development with the associated information related to the medical product in development.

### BRIEF SUMMARY OF THE INVENTION

The instant invention in one form is directed to a system for identifying regulatory pathways for medical product development is provided. The system includes a host server, a user authentication system, a user interface, a regulatory affairs pathway identification (RAPID) regulatory logic, and one or more regulatory databases. The host server is configured to store information for maintaining accessibility of the system. The user authentication system is configured to manage user accounts and authenticate users. The user interface is configured to present prompts and receive user responses. The regulatory logic is configured to analyze user responses and determine regulatory pathways. The regulatory database is configured to store regulatory information.

According to other aspects of the present disclosure, the system may include one or more of the following features. The user authentication system may be configured to store account preferences, payment methods, identified regulatory pathways, or product development information. The regulatory logic may be configured to communicate with the user interface to present prompts, questions, input fields, or guiding comments to the user. The regulatory logic may be configured to communicate with the regulatory database to ensure current and proper use of regulatory information. The regulatory database may store information on regulations, guidance documents, Acts of Congress, applicable fees, submission information or development timelines.

According to another aspect of the present disclosure, a method for identifying regulatory pathways for medical product development is provided. The method includes authenticating a user, initiating a regulatory pathway finder, displaying a user prompt, receiving a user response to the prompt, analyzing the user response using a regulatory logic, determining if there is an appropriate output pairing based on the user response, determining if a regulatory strategy is complete, and displaying the regulatory strategy.

According to other aspects of the present disclosure, the method may include one or more of the following features. The user prompt may be associated with a guiding comment. The regulatory logic may utilize one or more APIs to improve potential output pairings and displayed information. The regulatory logic may utilize an open-source code model allowing users to improve existing pathway analysis, potential output pairings, and displayed information. The displayed regulatory strategy may include one or more output pairings, a summarized regulatory strategy, a detailed regulatory strategy, an overview of potential regulatory strategies, or suggested regulatory strategies.

According to another aspect of the present disclosure, a non-transitory computer-readable medium storing instructions is provided. The instructions, when executed by a processor, cause the processor to perform operations including authenticating a user, initiating a regulatory pathway finder, displaying a user prompt, receiving a user response to the prompt, analyzing the user response using a regulatory logic, determining if there is an appropriate output pairing based on the user response, determining if a regulatory strategy is complete, and displaying the regulatory strategy.

According to other aspects of the present disclosure, the operations performed by the processor may include one or more of the following features. The user prompt may be a multiple-choice question, an open-ended question, or a Boolean question such as a true/false question. The guiding comment may be hidden until selected by the user. The displayed regulatory strategy may include selectable options to view detailed information about potential regulatory pathways with the ability to download a local copy of the information for future reference.

These and other objects, features, and advantages of the present invention will become more readily apparent from the attached drawings and the detailed description of the preferred embodiments, which follow.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 is a flowchart of the overall regulatory affairs pathway identification system;

FIG. 2 is a flowchart of a set of high-level steps that a system could perform to identify one or more regulatory pathway for medical product development;

FIG. 3 is a screenshot of a step in the regulatory pathway identification process showing a user prompt and user response options;

FIG. 4 is a screenshot of a different step in the regulatory pathway identification process showing a user prompt, user response options, and a guiding comment;

FIG. 5 is a screenshot of multiple potential regulatory pathways for a medical product; and

FIG. 6 is a screenshot of a detailed potential regulatory pathway which can be viewed by the user if their medical product were to qualify for that pathway.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

The terms “identification system” and “regulatory pathway identification system” may be used interchangeably are both used to mean an identification system which may be implemented in various embodiments.

The terms “RAPID regulatory logic” and “regulatory logic” are interchangeable and meant to mean the Regulatory Affairs Pathway Identification (RAPID) regulatory logic used to perform the instructions on identifying regulatory pathways for developing medical products. Regulatory logic is an aggregation of pertinent regulatory information which utilizes, but is not limited to, a branching logic as in a decision tree to be presented to an end user based on the end user's response(s) to one or more prompt(s) and/or question(s) without presenting an end user duplicative prompts or questions. The information presented becomes a tailored synopsis for the end user and presents only the pertinent or relevant questions or prompts based on the user's responses to one or more prompt(s) and/or question(s).

As this invention is susceptible to embodiments of many different forms, it is intended that the present disclosure be considered as an example of the principles of the invention and not intended to limit the invention to the specific embodiments shown and described.

While the disclosed applications of the technology disclosed herein satisfy a long-felt but unmet need in the art of regulatory pathway identification software, it should be understood that the technology is not limited to being implemented in the precise manners set forth herein, but could be implemented in other manners without undue experimentation by those of ordinary skill in the art in light of this disclosure. Accordingly, the examples set forth herein should be understood as being illustrative only, and should not be treated as limiting.

One aspect of this disclosure is directed to an identification system for identifying regulatory pathways for medical product development. The identification system includes a host server, a user authentication system, a user interface, regulatory logic for identifying a regulatory affairs pathway, and at least one regulatory database. The regulatory logic analyzes user responses to determine regulatory pathways based on information stored in the regulatory databases. The user authentication system stores account preferences, payment methods, identified regulatory pathways, or product development information. The regulatory logic communicates with the user interface to present prompts, questions, input fields, or guiding comments to the user. The regulatory database stores information on regulations, guidance documents, Acts of Congress, applicable fees, or development timelines. The identification system includes prompt display for presenting user prompts associated with guiding comments. The user prompts include multiple-choice questions, open-ended questions, or Boolean questions such as true/false questions. The guiding comments are hidden until selected by the user.

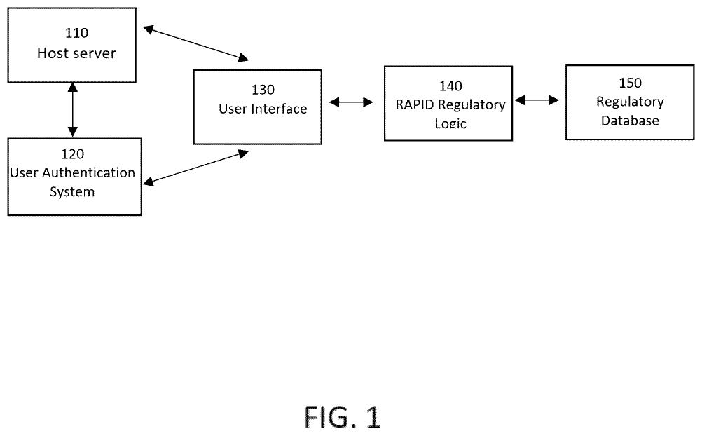

FIG. 1 shows a flowchart of the overall regulatory affairs pathway identification system. The system includes a host server 100, a user authentication system 120, a user interface 130, regulatory logic 140, and a regulatory database 150.

The host server 100 stores the needed information to keep the system's webpage or application up and accessible for users. The user authentication system 120 allows users to create and manage accounts, which could include, but is not limited to, account preferences, payment methods, identified regulatory pathways, product development information, or other information. The host server 100 interacts with the user authentication system 120 such that when a user attempts to access a private area of the website or application, the host server 100 triggers the user authentication system 120 to request the user's authentication information.

Once the user authentication system 120 determines whether the authentication information is accurate or inaccurate, the user authentication system 120 communicates the result to the host server 100, and the host server 100 shows the result to the user. If the authentication information is accurate, the host server 100 will then interact with the user interface 130 to take the user to the RAPID regulatory logic 140 landing page.

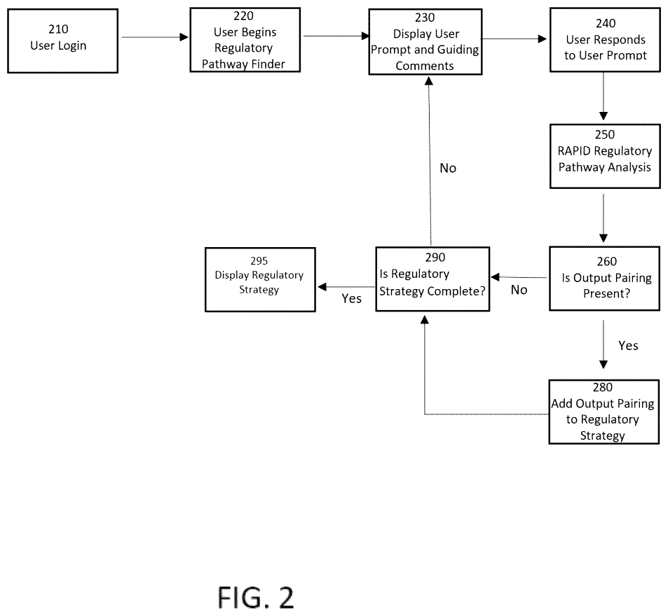

The landing page is a dashboard where the user may begin the user's path through the regulatory logic 140 or view prior regulatory developed regulatory strategies, which is further described in FIG. 2. As the user is guided through the regulatory logic 140, the regulatory logic 140 communicates with the user interface 130 to communicate necessary prompts, questioning, input, guiding comments, or other information to the user. The regulatory logic 140 also communicates with the regulatory database 150 to ensure all information is current and used properly. The regulatory database 150 houses information on various regulations, guidance documents, Acts of Congress, applicable fees, development timelines, and more that may or may not be relevant to a user's medical product development.

FIG. 2 shows a flowchart of a set of high-level steps that a system could perform to identify one or more possible regulatory affairs pathways for medical product development. The high-level steps include a user logging in 210, the user beginning a regulatory pathway finder 220, displaying a user prompt and guiding comments 230, the user responding to the user prompt 240, the identification system analyzing the user responses 250, determining whether there is an appropriate output pairing based on the user responses 260, determining whether the regulatory strategy is complete 290, and displaying the regulatory strategy 295.

In some embodiments, a user will first log in 210 to their account such that their account will store any regulatory strategies the user has created. However, in other embodiments, a user may not need to log in to run an analysis. Once the user logs in in this embodiment, the user may begin a regulatory pathway finder 220. Once the user enters the regulatory pathway finder, the regulatory pathway finder 220 presents prompts to the user 230. The user prompts 230 may be multiple choice questions, open-ended questions, true false questions, or other prompts. The user prompts 230 may be associated with a guiding comment. A guiding comment may be some text or other aid that assists, directs, or otherwise guides the user as the user formulates an answer to the user prompt. The user then may respond to the user prompt 240.

After the user responds, the response is fed as input into a decision-making logic structure 250. In one embodiment the decision-making logic structure may be called “RAPID”. The logic structure 250 analyzes the user response to determine if there is an output pairing 260 associated with that user response, if the regulatory strategy is complete at that point 290, and if not, what the next user response should be. If an output pairing 260 is found that is associated with the user response 240, the output pairing will be added to a custom regulatory strategy that is stored and revised throughout the analysis by logic structure 250. In some embodiments, an output pairing 260 may be associated with one or more specified user input via a linked-list, array, data table, or other mechanism. Once it is determined that the regulatory strategy is complete 290, the RAPID regulatory logic structure 250 analysis ends and any regulatory strategies are displayed 295 to show to the user. The display 295 may include one or more output pairings 260, a summarized regulatory strategy, a detailed regulatory strategy, an overview of one or more potential regulatory strategies, one or more suggested regulatory strategies, or other regulatory pathway information. In some embodiments, the logic structure 250 may utilize one or more APIs to improve potential output pairings 260 and displayed information to the user 295. The logic structure 250 may also utilize an open-source code model that would allow users to improve upon existing pathway analysis 250, potential output pairings, 260 and displayed information to the user 295.

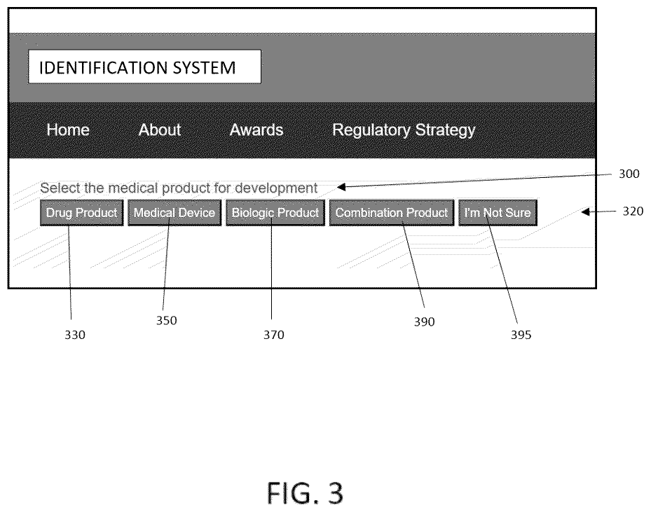

FIG. 3 shows a screenshot of a user interface usable to present a user prompt 300 such that a user can respond via one or more predetermined response buttons 320. This figure shows a multiple-choice user prompt 300 and user response 320 configuration.

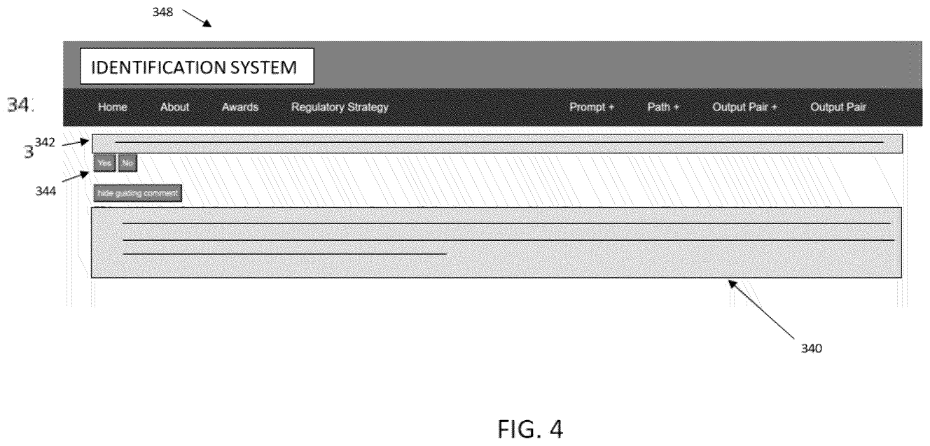

FIG. 4 shows a screenshot 348 of a user interface usable to present a user prompt 342 such that a user can respond via one or more predetermined response buttons 344. The guiding comment 340 may also be hidden until the user selects to show the potential guiding comment, which contains further information to assist in properly answering the user prompts 344. The guiding comment 340 in the example of FIG. 4 includes “FDA considerations for whether a device is intended to treat or diagnose a life threatening or irreversibly debilitating disease or condition include the intended treatment effect on a serious manifestation or symptom of the disease or condition such as improved diagnosis such as a disease or a condition, improved quality of life, or other beneficial effects. FDA provides a few examples of life-threatening diseases/conditions. These include but are not limited to: chronic or active hepatitis, myocardial infarction, cancer, and trauma. FDA clarifies what it considers to be irreversibly debilitating which is morbidity that has substantial impact on day-to-day functioning. Generally speaking, short lived and self-limiting morbidity will not be sufficient. Factors ultimately include; survival, day-to-day functioning, in likelihood, if left untreated, the disease or condition will progress to a more serious disease or condition.”

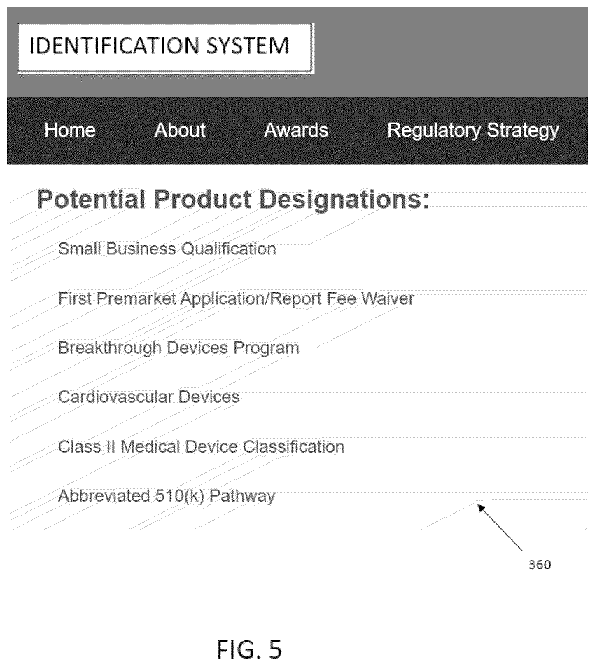

FIG. 5 shows a screenshot of a user interface or display 295 usable to present suggested regulatory pathways 360 based on the user's responses while using the regulatory pathway finder 220. These regulatory pathways 360 may be selected to read further, more detailed information 380.

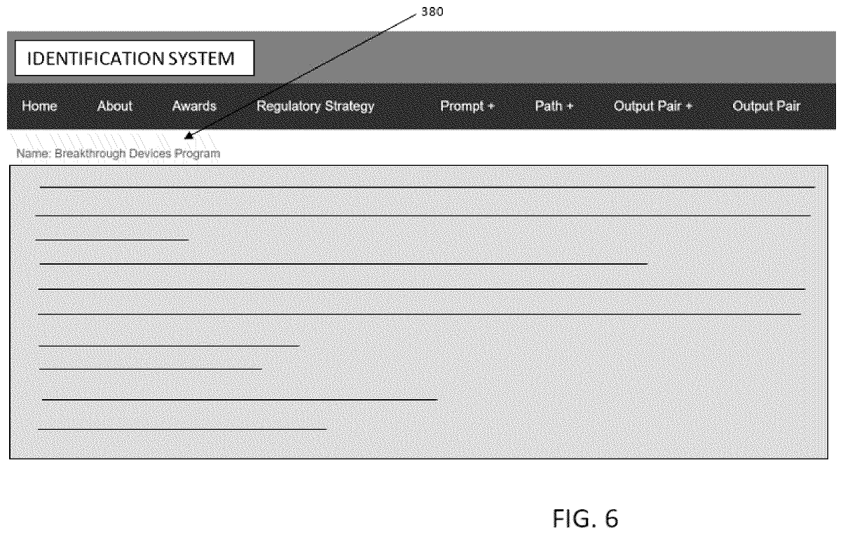

FIG. 6. shows a screenshot of a user interface which contains detailed information about one of the potential regulatory pathways available for a medical product 380. This detailed information about this output pairing 280 can be viewed and then the user can choose to return back to the interface or display 295 to review the other linked information regarding alternate regulatory pathways if available.

The Regulatory Affairs Pathway Identification System may provide a solution for identifying and analyzing potential regulatory pathways for medical product development. This system may assist users in navigating the complex landscape of regulatory requirements and options for various types of medical products. The system may utilize a series of user prompts and responses to gather relevant information about a specific medical product. The system may then analyze this information to determine potential regulatory pathways that may be applicable to the product.

The Regulatory Affairs Pathway Identification System may incorporate at least one database of current regulatory information, which may include regulations, guidance documents, and other relevant data. This database may be regularly updated to ensure the system provides accurate and up-to-date information to users. The system may present users with multiple potential regulatory pathways, allowing for comparison and evaluation of different options. The system may also provide detailed information about each potential pathway, including regulations, guidance documents, Acts of Congress, applicable fees, submission information or development timelines.

The Regulatory Affairs Pathway Identification System may be designed to accommodate various types of medical products, such as drugs, medical devices, biologics, and combination products. This versatility may allow the system to serve a wide range of users in the medical product development field. The system may include user authentication features, allowing users to create accounts and save their progress or results for future reference. This functionality may enhance the user experience and provide continuity for ongoing product development projects.

The Regulatory Affairs Pathway Identification System may serve as a valuable tool for medical product developers, regulatory affairs professionals, and others involved in the process of bringing new medical products to market. By streamlining the process of identifying and understanding regulatory pathways, the system may help users make informed decisions and potentially reduce time and resources spent on regulatory strategy development. The Regulatory Affairs Pathway Identification System may comprise several main components that work together to provide regulatory guidance for medical product development. In some cases, a host server 100 may serve as the central component of the system. The host server 100 may store and manage the information necessary to maintain the system's webpage or application accessibility for users. The host server 100 may also facilitate communication between other system components and handle data processing tasks.

A user authentication system 120 may be included in the system to manage user accounts and access. In some cases, the user authentication system may allow users to create and manage accounts. These accounts may include various types of information such as account preferences, payment methods, identified regulatory pathways, and product development information. The user authentication system may work in conjunction with the host server 100 to verify user credentials and grant appropriate access to system features.

A user interface 130 or dashboard may be incorporated into the system to facilitate user interaction. The user interface may provide a means for users to input information, navigate through the system, and view results. In some cases, the user interface may be designed to be intuitive and user-friendly, accommodating users with varying levels of technical expertise.

The system may include a regulatory logic component 140. The regulatory logic component may serve as the core decision-making engine of the system. The regulatory logic 140 may analyze user inputs, apply regulatory rules and guidelines, and generate appropriate regulatory pathway recommendations. In some cases, the regulatory logic 140 may utilize complex algorithms and decision trees to process information and provide accurate guidance.

At least one regulatory database 150 may be integrated into the system to store and manage regulatory information. The regulatory database 150 may house a wide range of data, including information on various regulations, guidance documents, Acts of Congress, applicable fees, submission information, and development timelines. In some cases, the regulatory database 150 may be regularly updated to ensure the system provides current and accurate information to users. The regulatory database 150 may serve as a comprehensive resource for the regulatory logic 140 to draw upon when analyzing user inputs, providing explanations and definitions, and generating recommendations.

These components may work in concert to provide users with a tool for navigating the complex developmental landscape of medical product regulatory pathways. By leveraging the capabilities of each component, the system may offer users valuable insights and guidance throughout the regulatory process.

The Regulatory Affairs Pathway Identification System may operate through a series of interconnected modules that guide users through the process of identifying potential regulatory pathways for medical product development. In some cases, the system operation may begin when a user interacts with a login module 210. The login module may interface with the user authentication system 120 to verify user credentials and grant access to the system.

Once authenticated, the user may be directed to a pathway finder 220. The pathway finder may serve as the starting point for the regulatory pathway identification process. In some cases, the pathway finder may present the user with initial options or categories to begin narrowing down the potential regulatory pathways applicable to the user's medical product.

As the user progresses through the system, a prompt display 230 may present various questions or prompts to gather information about the user's medical product. The prompt display 230 may work in conjunction with the user interface 130 to present information clearly and collect user input efficiently. In some cases, the user prompts may be multiple choice questions, open-ended questions, or Boolean questions such as true/false questions, depending on the nature of the information being sought.

A response module 240 may be responsible for capturing and processing user responses to the prompts. The response module 240 may work closely with the prompt display 230 and the user interface 130 to ensure accurate data collection. In some cases, the response module 240 may also perform initial validation of user inputs to ensure the collected data is in the correct format or within expected parameters.

An analysis module 250 may then process the user responses collected by the response module 240. The analysis module 250 may utilize complex algorithms and decision trees to evaluate the user's input against the regulatory information stored in the regulatory database 150. This analysis may help determine which regulatory pathways may be applicable to the user's medical product. As part of the analysis process, a pairing detector 260 may identify potential matches between the user's product characteristics and specific regulatory pathways or requirements. The pairing detector 260 may work in conjunction with the regulatory logic 140 to apply regulatory rules and guidelines to the user's input. When the pairing detector 260 identifies a relevant regulatory pathway or requirement, a strategy updater 280 may incorporate this information into a developing regulatory strategy for the user's product. The strategy updater 280 may compile and organize the identified pathways and requirements into a coherent strategy document. Throughout the process, a completion checker 290 may monitor the progress of the regulatory strategy development. The completion checker 290 may determine whether sufficient information has been gathered and analyzed to provide a comprehensive regulatory strategy. The system may allow a user to save their progress on a strategy to allow the user to return to the current prompt if not yet answered. In some cases, if the completion checker 290 determines that additional information is needed, the system may loop back to the prompt display 230 to gather more data from the user.

Once the completion checker 290 determines that the regulatory strategy is complete, one or more regulatory strategies are displayed 295 and may present the results to the user. The strategy display 295 may work with the user interface 130 to present the identified regulatory pathways, requirements, and other relevant information in a clear and organized manner. Throughout the user's interaction with the system, guiding comments may be available to provide additional context or clarification for specific prompts or questions. In some cases, the guiding comment may be hidden until the user selects to show the potential guiding comment. This feature may help users make informed decisions without overwhelming them with excessive information upfront.

The host server 100 may facilitate the flow of information between these various modules and components, ensuring smooth operation of the system. Additionally, the regulatory database 150 may be continuously updated to reflect the latest regulatory information, allowing the system to provide accurate and current guidance to users throughout the process.

The Regulatory Affairs Pathway Identification System may incorporate various user interface 130 elements to facilitate user interaction and guide users through the regulatory pathway identification process. These elements may be designed to provide a clear and intuitive experience for users as they navigate the complexities of medical product regulation. The system may present a product selection prompt 300 to users. A product selection prompt 300 may be displayed on the user interface 130 and may ask users to specify the type of medical product they are developing. The product selection prompt 300 may include options such as drug products 330, medical devices 350, biologic products 370, combination products 390, or an option for users who are unsure 395 about their product classification.

To allow users to respond to the product selection prompt 300, the system may provide response buttons 320. Response buttons 320 may be interactive elements on the user interface 130 that users can click or tap to select their desired option. In some cases, the response buttons 320 may be arranged in a vertical list or a grid layout for easy navigation.

The system may also incorporate guidance text 340 to assist users in understanding and responding to prompts. Guidance text 340 may provide additional context, explanations, or examples related to the current prompt or question. In some cases, the guidance text 340 may be initially hidden and revealed when users request additional information, helping to maintain a clean and uncluttered interface while still providing detailed support when needed.

As users progress through the regulatory pathway identification process, the system may present a pathway list 360. A pathway list 360 may display potential regulatory pathways or product designations that may be applicable based on the user's responses. The pathway list 360 may be dynamically updated as the user provides more information through the prompt display 230 and response module 240.

The user interface 130 may be designed to work seamlessly with other system components. For example, the prompt display 230 may utilize the user interface 130 to present questions and prompts to users, while the response module 240 may capture user inputs through the interface elements such as the response buttons 320. The regulatory logic 140 may influence the content and sequence of prompts and guidance text presented through the user interface 130. The regulatory database 150 may provide up-to-date information that informs the content of prompts, guidance text, and pathway lists displayed to users. The login module 210 may also utilize the user interface 130 to present login screens and capture user credentials. Once authenticated, users may be directed to the pathway finder 220, which may present initial options or categories through the user interface 130 to begin the regulatory pathway identification process.

As the analysis module 250 processes user responses, the pairing detector 260 may identify relevant regulatory pathways. These identified pathways may be incorporated into the pathway list 360 displayed on the user interface 130. The strategy updater 280 may use this information to compile a regulatory strategy, which may be presented to the user through the strategy display 295 component of the user interface 130.

Throughout the process, the completion checker 290 may monitor progress and determine if additional information is needed. If more information is required, the system may loop back to present additional prompts through the prompt display 230 and user interface 130.

The Regulatory Affairs Pathway Identification System may include a feature for displaying detailed information about specific regulatory pathways. This feature may be accessed through the strategy display 295, allowing users to view comprehensive information about potential regulatory options for their medical product.

In some cases, the system may present regulatory pathway details 380 through the user interface 130. The regulatory pathway details 380 may include a variety of information relevant to a specific regulatory pathway or product designation. This information may be sourced from the regulatory database 150 and organized by the regulatory logic 140 to provide users with a clear and comprehensive overview of the chosen pathway.

The regulatory pathway details 380 may be presented in a structured format to enhance readability and user comprehension. For example, the information may be organized into sections or categories, each addressing different aspects of the regulatory pathway. These sections may include, but are not limited to:
1. Submission criteria
2. Key features of the pathway
3. Applicable Code of Federal Regulations (CFR) sections
4. Relevant laws and Acts of Congress
5. FDA resources and guidance documents

The regulatory pathway details 380 may be displayed on a dedicated screen or page within the user interface 130. The screen may include a navigation bar at the top, allowing users to access other system features or return to previous sections. The navigation bar may include options such as “Home,” “About,” “Awards,” and “Regulatory Strategy.”

The strategy display 295 may present the regulatory pathway details 380 in various formats to suit different user needs. In some cases, the strategy display 295 may provide a summarized regulatory strategy, offering a concise overview of the key points and requirements for a specific pathway. Alternatively, the strategy display 295 may present a detailed regulatory strategy, providing in-depth information about all aspects of the chosen pathway.

In some implementations, the strategy display 295 may offer an overview of multiple potential regulatory strategies. This feature may allow users to compare different pathways side by side, helping them make informed decisions about their product development approach. The strategy display 295 may also present one or more suggested regulatory strategies based on the user's input and the analysis performed by the analysis module 250 and pairing detector 260.

The regulatory pathway details 380 may be dynamically generated based on the user's interactions with the system. As users progress through the prompt display 230 and response module 240, the regulatory logic 140 may refine the displayed information to ensure relevance and accuracy. The strategy updater 280 may continuously update the regulatory pathway details 380 as new information becomes available or as the user's product development strategy evolves.

In some cases, the regulatory pathway details 380 may include interactive elements. For example, users may be able to expand or collapse certain sections to view more or less detail as needed. The user interface 130 may also provide links to external resources or additional information within the regulatory database 150, allowing users to explore specific topics in greater depth.

The host server 100 may facilitate the retrieval and display of regulatory pathway details 380, ensuring that the information presented is up-to-date and accurate. The authentication system 120 may also play a role in this process, ensuring that users have appropriate access to detailed regulatory information based on their account permissions or subscription level.

By providing and well-organized regulatory pathway details 380, the Regulatory Affairs Pathway Identification System may help users navigate the complex landscape of medical product regulation more effectively. This feature may support informed decision-making and streamline the process of developing regulatory strategies for various types of medical products.

The Regulatory Affairs Pathway Identification System may integrate various components and modules to provide a solution for identifying regulatory pathways for medical product development. The system's components may work in concert to guide users through the process of determining appropriate regulatory strategies. The host server 100 may serve as the central hub, facilitating communication between different system components. The host server 100 may interact with the authentication system 120 to verify user credentials and manage access to the system's features.

The user interface 130 may provide the primary means for users to interact with the system. Through the user interface 130, users may input information, navigate through different sections, and view results. The user interface 130 may work in conjunction with the prompt display to present questions and gather user responses via the response buttons. The regulatory logic 140 may serve as the core decision-making engine of the system. In some cases, the regulatory logic 140 may analyze user inputs, apply regulatory rules, and generate appropriate regulatory pathway recommendations. The regulatory logic 140 may utilize the information stored in the regulatory database to ensure that recommendations are based on current regulatory requirements.

The pathway finder may initiate the regulatory pathway identification process by presenting users with initial options or categories. As users progress through the system, the prompt display may present various questions or prompts to gather information about the user's medical product. The response module may capture and process user responses to these prompts.

The analysis module may then process the user responses collected by the response module. In some cases, the analysis module may evaluate the user's input against the regulatory information stored in the regulatory database. The pairing detector may identify potential matches between the user's product characteristics and specific regulatory pathways or requirements.

When the pairing detector identifies a relevant regulatory pathway or requirement, the strategy updater may incorporate this information into a developing regulatory strategy for the user's product. The completion checker may monitor the progress of the regulatory strategy development and determine whether sufficient information has been gathered and analyzed.

Once the completion checker determines that the regulatory strategy is complete, the strategy display may present the results to the user. The strategy display may present the identified regulatory pathways, requirements, and other relevant information in a clear and well-organized manner. The regulatory logic may utilize an open-source code model. This approach may allow users to contribute to and improve upon existing pathway analysis methods, potential output pairings, and the information displayed to users. By leveraging the collective expertise of its user base, the system may continuously evolve and enhance its capabilities.

The regulatory logic may also incorporate one or more Application Programming Interfaces (APIs) to enhance its functionality. These APIs may be used to improve the identification of potential output pairings and refine the information displayed to users. For example, an API may connect the system to external databases or resources, allowing for real-time updates to regulatory information or access to additional data sets that may inform the pathway identification process.

An integrated approach may provide users with a streamlined experience for navigating the complex landscape of medical product regulation. For instance, a user developing a novel medical device may begin by selecting “Medical Device” from the product selection prompt. The system may then guide the user through a series of questions about the device's characteristics, intended use, and potential risks.

As the user provides responses, the analysis module may process this information and consult the regulatory database to identify potential regulatory pathways. The pairing detector may match the device's characteristics with specific regulatory requirements, such as the need for clinical trials or specific safety testing.

Throughout this process, the strategy updater may compile the identified pathways and requirements into a coherent regulatory strategy. The completion checker may ensure that all necessary information has been gathered before the strategy display presents the final results to the user.

In some embodiments the method or methods described above may be executed or carried out by a computing system including a tangible computer-readable storage medium, also described herein as a storage machine, that holds machine-readable instructions executable by a logic machine (i.e. a processor or programmable control device) to provide, implement, perform, and/or enact the above-described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard or gaming controller. For example, a user input may indicate a request that certain task is to be executed by the computing system, such as requesting the computing system to display any of the above-described information, or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An identification system for identifying regulatory pathways for medical product development, comprising:
a host server;
a user authentication system;
a user interface;
regulatory logic for identifying a regulatory affairs pathway; and
at least one regulatory database,
wherein the regulatory logic analyzes user responses and determine regulatory pathways based on information stored in the at least one regulatory database.

2. The identification system of claim 1, wherein the user authentication system is configured to store account preferences, payment methods, identified regulatory pathways, or product development information.

3. The identification system of claim 1, wherein the regulatory logic is configured to communicate with the user interface to present prompts, questions, input fields, or guiding comments to the user.

4. The identification system of claim 1, wherein the at least one regulatory database stores information on regulations, guidance documents, Acts of Congress, applicable fees, and/or development timelines.

5. The identification system of claim 1, further comprising a prompt display configured to present user prompts associated with guiding comments.

6. The identification system of claim 5, wherein the user prompts comprise multiple choice questions, open-ended questions, or Boolean questions such as true/false questions.

7. The identification system of claim 6, wherein the guiding comments are hidden until selected by the user.

8. A method for identifying regulatory pathways for medical product development, comprising:
authenticating a user;
initiating a regulatory pathway finder;
displaying a user prompt;
receiving a user response to the prompt;
analyzing the user response using regulatory logic, the user response including information on a specific medical product for pathway identification;
determining if there is an appropriate output pairing based on the user response;
determining if a regulatory strategy is complete; and
if the regulatory strategy is complete, displaying the regulatory strategy.

9. The method of claim 8, wherein the user prompt is associated with a guiding comment that provides additional context or clarification for the prompt.

10. The method of claim 9, wherein the guiding comment is initially hidden and revealed upon user request.

11. The method of claim 8, wherein analyzing the user response using the regulatory logic comprises utilizing one or more APIs to improve potential output pairings.

12. The method of claim 11, wherein the regulatory logic utilizes an open-source code model allowing users to improve existing pathway analysis.

13. The method of claim 8, wherein displaying the regulatory strategy comprises presenting one or more of: output pairings, a summarized regulatory strategy, a detailed regulatory strategy, an overview of potential regulatory strategies, or suggested regulatory strategies.

14. The method of claim 13, further comprising a step of allowing the user to select and view detailed information about specific potential regulatory pathways.

15. A non-transitory computer-readable medium storing instructions that, when executed by a processor, cause the processor to perform operations for identifying regulatory pathways for medical product development, the operations comprising:
authenticating a user;
initiating a regulatory pathway finder;
displaying a user prompt;
receiving a user response to the prompt;
analyzing the user response using regulatory logic;
determining if there is an appropriate output pairing based on the user response;
determining if a regulatory strategy is complete; and
displaying the regulatory strategy.

16. The non-transitory computer-readable medium of claim 15, wherein the user prompt is associated with a guiding comment that provides additional context or clarification for the prompt.

17. The non-transitory computer-readable medium of claim 16, wherein the guiding comment is initially hidden and revealed upon user request.

18. The non-transitory computer-readable medium of claim 15, wherein analyzing the user response using the regulatory logic comprises utilizing one or more APIs to improve potential output pairings.

19. The non-transitory computer-readable medium of claim 18, wherein the regulatory logic utilizes an open-source code model allowing users to improve existing pathway analysis.

20. The non-transitory computer-readable medium of claim 19, wherein displaying the regulatory strategy comprises presenting one or more of: output pairings, a summarized regulatory strategy, a detailed regulatory strategy, an overview of potential regulatory strategies, or suggested regulatory strategies.
